(19) United States
(12) Patent Application Publication
(10) Pub. No.: US 2010/0082772 A1
(43) Pub. Date: Apr. 1, 2010

(54) COMMUNICATION DEVICE AND COMPUTER USABLE MEDIUM THEREFOR

(75) Inventor: Satoshi SUZUKI, Nagoya (JP)

Correspondence Address: Scully, Scott, Murphy &Presser, P.C., 400 Garden City Plaze, Suite 300, Garden City, NY, 11530, US

(73) Assignee: BROTHER KOGYO KABUSHIKI KAISHA, Aichi (JP)

(21) Appl. No.: 12/565,241

(22) Filed: Sep. 23, 2009

(30) Foreign Application Priority Data
Sep. 26, 2008 (JP) 2008-248603

(51) Int. Cl. G06F 15/16

(52) U.S. Cl. 709/219; 709/248

(57) ABSTRACT

A communication device to communicate with a responsive server via a network to obtain the time information from the responsive server is provided. The responsive server is capable of responding to a request for time information issued by the communication device. The communication device includes a preliminary data transmitter configured to transmit preliminary data to the responsive server, prior to transmitting the request for time information, and a time information requester configured to transmit the request for the time information to the responsive server and receive the time information which is transmitted from the responsive server in response to the request.

### CROSS REFERENCE TO RELATED APPLICATION

This application claims priority from Japanese Patent Application No. 2008-248603, filed on Sep. 26, 2008, the entire subject matter of which is incorporated herein by reference.

### BACKGROUND

1. Technical Field

An aspect of the present invention relates to a communication device to communicate with an external device via a network and a computer usable medium therefor.

2. Related Art

Conventionally, a technique to correct time running in a communication device within a network has been known. For example, Japanese Patent Provisional Publication No. 2005-195507 discloses a network system in which time information is obtained from an external device being a time server via a network, and time running in a communication device is corrected based on the obtained time information.

### SUMMARY

According to the disclosure, when the communication device and the external device communicate with each other via the network, duration of communication taken between the external device and the communication device varies depending on timing in which the communication takes place. Generally, when the duration of communication becomes longer, various problems are likely to occur. In particular, when the communication device attempts to obtain the time information during long-lasting communication, delivery of the time information to the communication device may be delayed due to network conditions; therefore, obtainment of the correct time to update the clock accurately becomes difficult. Moreover, when duration of communication between the communication device and the time server becomes longer, measuring an accurate communication period becomes also difficult. Because the time running in the communication device is updated based on the obtained time information and a communication period taken to obtain the time information, when the communication period is not measured accurately, the time may not be updated correctly.

In view of the above drawbacks, the present invention is advantageous in that a communication device capable of communicating with an external device via a network, in which deficiencies caused by long-lasting and varied duration of communication are effectively controlled, is provided. Specifically, a communication device which is capable of obtaining the time information with shorter time-lag and capable of measuring accurate communication periods is provided. Further, a computer usable medium to store computer readable instructions to manipulate the communication device to obtain the time information from the external device is provided.

According to an aspect of the present invention, a communication device to communicate with a responsive server via a network is provided. The responsive server is capable of responding to a request for time information issued by the communication device. The communication device includes a preliminary data transmitter configured to transmit preliminary data to the responsive server, prior to transmitting the request for time information, and a time information requester configured to transmit the request for the time information to the responsive server and receive the time information which is transmitted from the responsive server in response to the request.

When a communication device communicates with a responsive server within a network, duration of round-trip communication between the communication device and the responsive server often varies depending on timings in which the communication is taken. However, it is noted that duration of second or later round-trip communication between the same devices is shorter than duration of initial round-trip communication. Therefore, in the above communication device, timing-critical time information is requested and obtained in the shortened second or later communication between the communication device and the responsive server. Therefore, the time information can be obtained with less time-lag between issuance and receipt of the time information.

According to another aspect of the present invention, a communication device to communicate with a responsive server via a network is provided. The responsive server is capable of responding to data transmitted from the communication device. The communication device includes a preliminary data transmitter configured to transmit preliminary data to the responsive server, prior to transmitting primary data, and a duration measurer that transmits the primary data to the responsive server in order to measure and collect duration of round-trip communication between the communication device and the responsive server responding to the primary data.

According to the above configuration, duration of the shortened second or later round-trip communication between the communication device and the responsive server is measured so that accurate duration of the round-trip communication with less communication delay can be obtained.

According to still another aspect of the present invention, a computer usable medium to store computer readable instructions is provided. The instructions manipulate a communication device to communicate with a responsive server via a network. The responsive server is capable of responding to a request for time information issued by the communication device. The instructions manipulate the communication device to transmit preliminary data to the responsive server, prior to transmitting the request for time information, transmit the request for the time information to the responsive server, and receive the time information which is transmitted from the responsive server in response to the request.

According to the above configuration, timing-critical time information is requested and obtained in the shortened second or later communication between the communication device and the responsive server. Therefore, the time information can be obtained with less time-lag between issuance and receipt of the time information.

According to still another aspect of the present invention, a computer readable medium to store computer readable instructions is provided. The instructions manipulate a communication device to communicate with a responsive server via a network. The responsive server is capable of responding to data transmitted from the communication device. The instructions manipulate the communication device to transmit preliminary data to the responsive server, prior to transmitting the primary data, transmit the primary data to the responsive server, and transmit the primary data to the responsive server in order to measure and collect duration of round-trip communication between the communication device and the responsive server responding to the primary data.

According to the above configuration, duration of the shortened second or later round-trip communication between the communication device and the responsive server is measured so that accurate duration of the round-trip communication with less communication delay can be obtained.

### BRIEF DESCRIPTION OF THE ACCOMPANYING DRAWINGS

FIG. 1 is a schematic diagram to illustrate a time information acquisition system 1 according to an embodiment of the present invention.

FIG. 2 is a block diagram to illustrate an overall configuration of an MFP (multi-function peripheral) 10 according to the embodiment of the present invention.

FIG. 3 illustrates entry tables according to the embodiment of the present invention.

FIG. 4A is a flowchart to illustrate a time information provider selecting process to be performed in the MFP 10 according to the embodiment of the present invention. FIG. 4B is a flowchart to illustrate a round-trip duration measuring process included in the time information provider selecting process to be performed in the MFP 10 according to the embodiment of the present invention.

FIG. 5 is a flowchart to illustrate a time information acquiring process to be performed in the MFP 10 according to the embodiment of the present invention.

### DETAILED DESCRIPTION

Hereinafter, an embodiment according to an aspect of the present invention will be described with reference to the accompanying drawings.

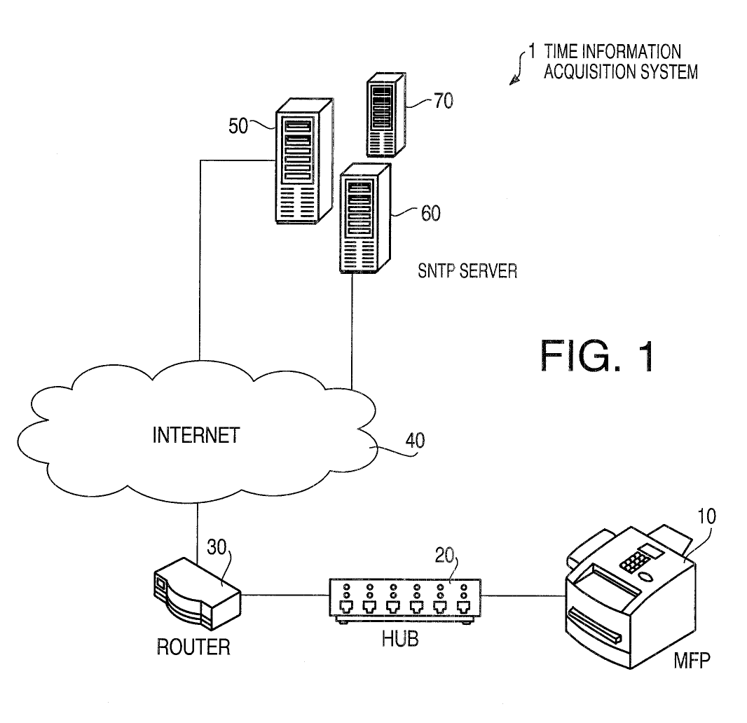

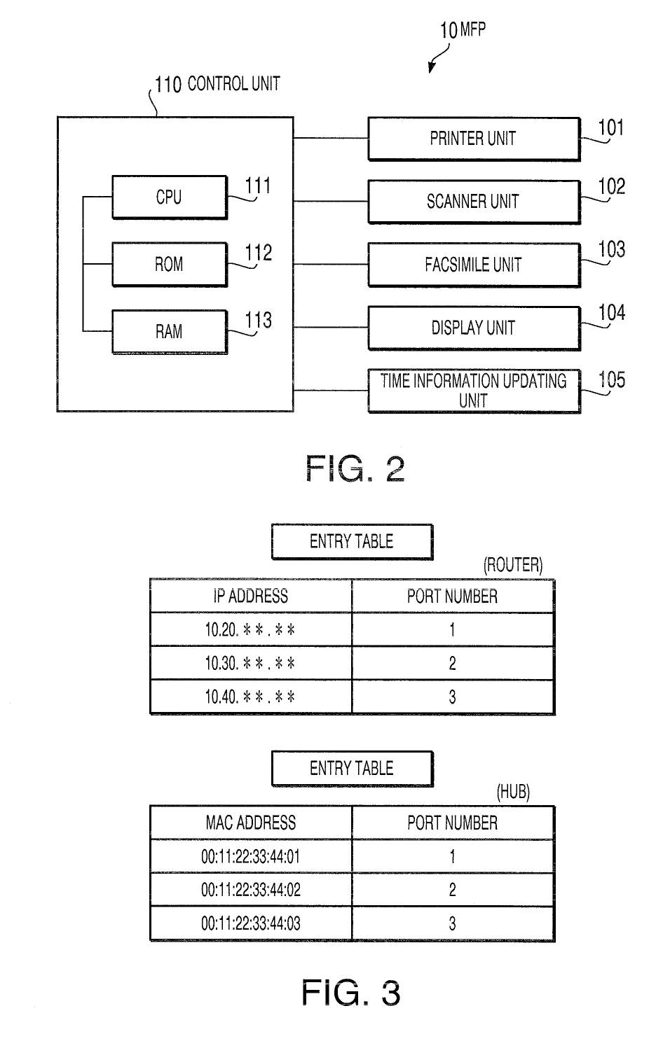

FIG. 1 is a schematic diagram to illustrate a time information acquisition system 1 according to an embodiment of the present invention. FIG. 2 is a block diagram to illustrate an overall configuration of an MFP (multi-function peripheral) 10 according to the embodiment of the present invention.

As shown in FIG. 1, the time information acquisition system 1 is a network system, in which the MFP 10 can communicate with a plurality of SNTP (Simple Network Time Protocol) servers (hereinafter “time servers”) 50, 60, 70 via a network 40 such as the Internet, and obtains the time information indicating latest time from one of the time servers 50, 60, 70.

The MFP 10 is connected to the network 40 via a known hub 20 and a router 30. The network 40 may include additional network relaying devices such as routers, hubs, and gateways (not shown).

As shown in FIG. 2, the MFP 10 includes a control unit 110 to control behaviors of the MFP 10. The control unit 110 being a microcomputer includes a CPU 111, a ROM 112, and a RAM 113. Each behavior of the MFP 10 is performed under control of the control unit 110 based on programs stored in the ROM 112. In particular, the MFP 10 is provided with a printer unit 101, a scanner unit 102, a facsimile unit 103, a display unit 104, and a time information updating unit 105. Functions equipped to each of the units are utilized according to programs stored in the ROM 112 under control of the control unit 110. The time information updating unit 105 serves to obtain the time information from one of the time servers 50, 60, 70 so that time running in the MFP 10 is updated and the updated time is displayed in the display unit 104, and to communicate with a server (not shown) provided by a manufacturer of the MFP 10 in order to update software programs installed in the MFP 10 itself.

When the MFP 10 updates the software programs installed in the MFP 10 itself, known Kerberos Authentication using time information within the MFP 10 may be used. Relaying devices such as the hub 20 and the router 30 store entry tables (see FIG. 3). In the entry tables, communication correspondence between destination devices within the network 40 and interface numbers of the hub 20 (or the router 30) associated with the destination devices respectively is indicated. More specifically, the entry table in the router 30 indicates association between an IP address of the destination device and a port number (i.e., connectors) in the router 30 itself, which is to be used to communicate with the destination device. The entry table in the hub 20 indicates association between a MAC address of the destination device and the port number of the hub 20 to be used. When communication is established, the router 30 or the hub 20 determines the port number, to which the destination device is connected at the other end, with reference to the entry table. When the port number is determined, the router 30 or the hub 20 transmits data through the determined port. When the router 30 or the hub 20 attempts to transmit data to an unregistered destination device, which is not included in the entry table, the relaying device inquires about the destination device and obtains the IP address or the MAC address in order to register the information in the entry table so that the communication with the destination device can be established based on the entry table in succeeding communication.

Generally, a number of entries to be registered in the entry tables is limited. Therefore, the destination devices, which have not been used for a predetermined period of time, may be deleted automatically by the hub 20 or the router 30.

Next, behaviors of the MFP 10 according to the embodiment of the present invention will be described. In the time information acquisition system 1 with above configuration, when the hub 20 or the router 30 does not have the information of the time servers 50, 60, 70 in the entry tables, it is required that the hub or the router 30 register the information of the time servers 50, 60, 70 in the entry tables. In such cases, due to the necessity for registering the information of the time servers 50, 60, 70 in the entry tables, communication between the MFP 10 and the unregistered time servers 50, 60, 70 via the hub 20 or the router 30 tend to require longer time, specifically for the MFP 10 initially transmitting data (e.g., a request for the time information, a ping command, etc.) to the time servers 50, 60, 70. It is to be noted that, once the time servers 50, 60, 70 are registered in the entry tables, reply transmission of data (e.g., the time information and a reply in response to the ping command) from the time servers 50, 60, 70 to the MFP 10 tend not to take as long as the initial data transmission from the MFP 10 to the time servers 50, 60, 70.

Therefore, the MFP 10 according to the present embodiment is configured to register the information of the destination devices in the entry tables of the relaying devices (i.e., the hub 20 and the router 30) in association with the interface numbers of the relaying devices prior to executing any delay-critical action, which may cause some problems in succeeding operations in the time information acquisition system 1 due to the communication delay, and execute the action after registration of the communication correspondences. The action includes, for example, requesting the time information and measuring duration of communication (i.e., between data transmission and receipt of reply data).

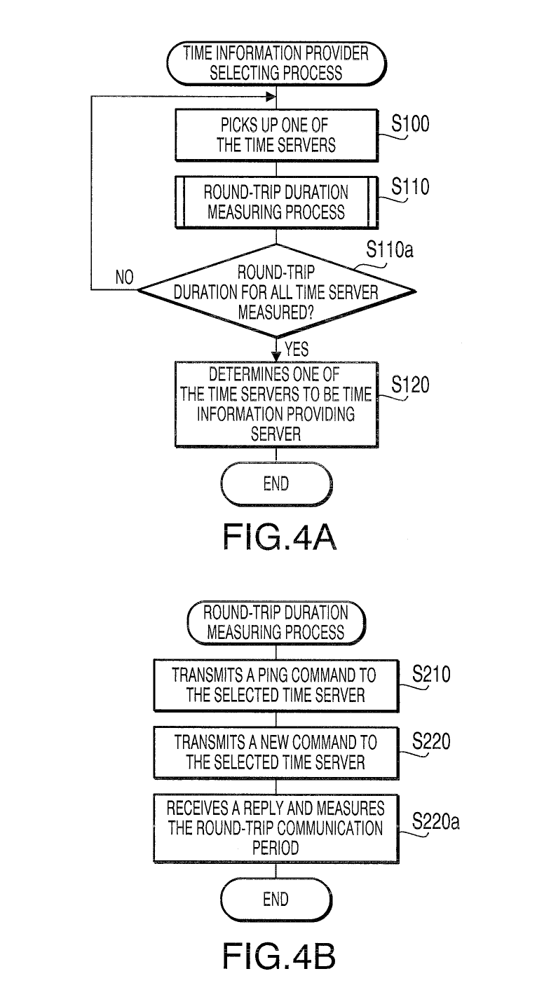

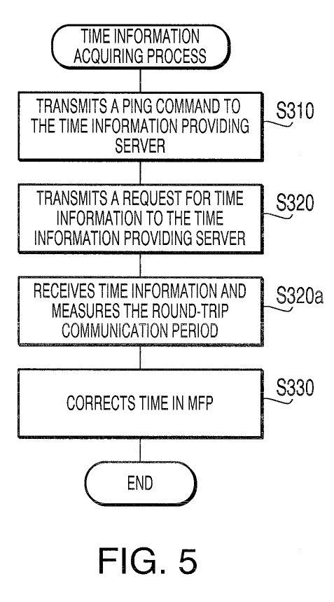

Behaviors of the MFP 10 to obtain the time information and measure duration of communication based on such tendencies will be described more specifically with reference to FIGS. 4A, 4B, and 5. FIG. 4A is a flowchart to illustrate a time information provider selecting process to be performed by the control unit 110 of the MFP 10 according to the embodiment of the present invention, and FIG. 4B is a flowchart to illustrate a round-trip duration measuring process included in the time information provider selecting process and to be performed in the MFP 10 according to the embodiment of the present invention. FIG. 5 is a flowchart to illustrate a time information acquiring process to be performed by the control unit 110 of the MFP 10 according to the embodiment of the present invention.

The time information provider selecting process shown in FIG. 4A is activated periodically at a predetermined interval (e.g., once in a week). When the process starts, in S100, the control unit 110 picks up one of the time servers 50, 60, 70 which are destination devices preliminarily registered in the ROM 112 of the control unit 110, to perform the round-trip duration measuring process. In the present embodiment, the control unit 110 picks up the time server 50 firstly. In S110, the control unit 110 performs the round-trip duration measuring process to measure and collect a period taken in round-trip communication between the MFP 10 and the time server 50.

The round-trip duration measuring process will be described with reference to FIG. 4B. In the present embodiment, the process is performed firstly to the time server 50 among the plurality of the registered time servers 50, 60, 70, and the remaining time servers 60, 70 will be picked up to be processed in the round-trip duration measuring process sequentially. In S210, the control unit 110 transmits a ping command to the time server 50 for a predetermined number of times, which is at least once, at a predetermined interval (e.g., an expected length of period between transmission of the command and completion of receiving response data returned in response to the command).

In this regard, when the ping command is transmitted to the time server 50 through the relaying device (e.g., the router 30 or the hub 20), and if the entry table of the relaying device does not include the information of the time server 50, the information of the time server 50 is registered in the entry table. Thus, the initial transmission of the ping command may take longer time. The ping command is therefore provided preliminarily to have the relaying devices register the time server 50 before measuring practical duration of the communication between the MFP 10 and the time server 50.

The ping command in S210 is transmitted to request for minimal acknowledgment from the time server 50 so that the time server 50 can respond in shorter processing time. According to the present embodiment, it is preferable that the ping command is repeatedly transmitted to the time server 50 for a plurality of times (e.g., 5 times). The ping commands issued in a plurality of times may be transmitted to the destination device through different communication paths in the network 40; therefore, more than one relaying device can relay the ping command, and the communication correspondence between the time server 50 and the relaying device can be registered in the entry tables of more than one relaying device. When the control unit 110 receives a reply command from the timer server 50 in response to the ping command, the flow proceeds to S220.

In S220, the control unit 110 transmits a new command to the time server 50 which responded to the previous ping command. The new command may be, for example, another ping command or a request for time information to the time server 50. Further, in S220a, when the control unit 110 receives a second reply from the time server 50 in response to the second command, the control unit 110 measures a period of communication taken between the MFP 10 and the time server 50. In particular, the control unit 110 measures and collects a period being duration for the round-trip communication between the transmission of the second command in S220 and receipt of the second reply command received in the control unit 110 in response to the second command in S220a. The round-trip duration measuring process ends thereafter. The flow returns to the time information provider selecting process shown in FIG. 4A.

Following S110 in FIG. 4A, in S110a, the control unit 110 examines as to whether periods of round-trip communication taken with all the time servers 50, 60, 70 have been collected. If a period of the round-trip communication with the other time servers 60, 70 remains uncollected (S110a: NO), the flow returns to S100. If periods of round-trip communication with all the time servers 50, 60, 70 have been collected (S110a: YES), the flow proceeds to S120.

In S120, the control unit 110 determines one of the time servers 50, 60, 70, which recorded a shortest period for the round-trip communication with the MFP 10 in the round-trip duration measuring process in S110. Further, the control unit 110 registers the determined time server to be a time information providing server and stores information concerning the determined time server in the RAM 113. The time information provider selecting process ends thereafter.

Next, a time information acquiring process to be performed in the MFP 10 will be described. FIG. 5 is a flowchart to illustrate the time information acquiring process to be performed in the MFP 10 according to the embodiment of the present invention. The time information acquiring process is activated periodically at a predetermined interval, which may be equivalent to the interval of the time information provider selecting process. Alternatively, the activating interval for the time information acquiring process may be shorter than the interval of the time information provider selecting process (e.g., once in a day).

When the time information acquiring process starts, in S310, the control unit 110 transmits a preliminary ping command to the time information providing server for a predetermined number of times at a predetermined interval (e.g., an expected length of period between transmission of the command and completion of receiving a reply in response to the command). In this step, in the same reason for the initial ping command repeatedly transmitted in S210 in the round-trip duration measuring process (see FIG. 4B), it is preferable that the preliminary ping command is repeatedly transmitted to the time server 50 for a plurality of times (e.g., 5 times). When the control unit 110 receives a reply from the time information providing server in response to the preliminary ping command, the flow proceeds to S310. In S320, the control unit 110 communicates with the time information providing server and in S320a obtains time information from the time information providing server. In particular, in S320, the control unit 110 transmits a request command for the time information to the time information providing server, and the time information providing server receiving the request command returns the time information in reply. When the control unit 110 receives the reply in S320a, the control unit 110 measures the period between transmission of the request command and receipt of the reply (i.e., the time information).

Following S320a, in S330, the control unit 110 adjusts the obtained time information and updates the time running in the MFP 10 according to the adjusted time information. In particular, adjustment is made such that the control unit 110 obtains the period between transmission of the request command for the time information in S320 and receipt of the replied time information in S320a. The control unit 110 divides the length of the obtained period for the round-trip communication in two and adds the halved length of the obtained period to the time indicated in the obtained time information. The flow ends thereafter. As time elapses, henceforth, the MFP 10 adds a length of the elapsed period to the corrected time so that operations in the MFP 10 are carried out in accordance with the updated time.

According to the above embodiment, the MFP 10 communicates with one of the time servers 50, 60, 70, which returns a reply in response to a request from the MFP 10, for the time information through the network 40. In particular, the control unit 110 transmits a request for the time information to one of the time servers 50, 60, 70 at a primary timing (S320) and obtains the time information transmitted from the time information providing server (S320a), which is one of the time servers 50, 60, 70. It is to be noted that the MFP 10 transmits initial data (i.e., the preliminary ping command), which conditions the communication paths between the MFP 10 and the time servers 50, 60, 70, preliminarily to the time servers 50, 60, 70 at a preliminary timing (S310) prior to the primary timing (S320) so that the information of the time servers 50, 60, 70 is registered in the entry tables of the relaying devices and, therefore, succeeding communication between the registered time servers 50, 60, 70 and the MFP 10 is carried out in shortened and practical periods of time. Therefore, the time information, which is more accuracy-emphasized, is obtained with less time-lag in the delay-conditioned second or later communication in the above embodiment.

According to the above embodiment, the MFP 10 transmits the request command for the time information to the time information providing server (S320) and measures duration between the transmission of the request command and receipt of the reply command from the time information providing server in S320a, which is after the first round-trip communication in S310. Because duration for the second or later round-trip communication is shortened by the conditioning effect of the preceding communication including the preliminary ping command, the period for the second or later round-trip communication to obtain the time information can be measured with less time-lag and more accurately.

According to the above embodiment, the MFP 10 is connected with the plurality of time servers 50, 60, 70 so that the preliminary data (i.e., the ping commands) can be transmitted to the time servers 50, 60, 70 respectively (S210), and duration for round-trip communication between transmission of the primary data (i.e., the second ping command or other command for measuring duration in S220a) and receipt of the reply data is measured. In other words, the MFP 10 transmits the preliminary data to the time servers 50, 60, 70 (S210) prior to transmitting the primary data to the time servers 50, 60, 70 respectively (S220) so that the information of the time servers 50, 60, 70 is registered in the entry tables of the relaying devices and the networking paths between the MFP 10 and the time servers 50, 60, 70 are conditioned, and the primary data can be transmitted in the delay-conditioned second or later communication. The MFP 10 thus collects and compares the periods taken in each second round-trip communication. Thus, one of the time servers 50, 60, 70 which recorded the shortest period for the round-trip communication is determined to be the time information providing server. The MFP 10 thereafter transmits a request for time information to the time information providing server and obtains the time information.

According to the MFP 10 in the above embodiment, the period for round-time communication to be measured in S220a is shortened by the preceding and preliminary communication in S210 so that the time information can be obtained in S320a from the time information providing server which recorded the shortest duration for the round-trip communication in S220a. Thus, the accuracy-improved time information can be obtained with less time-lag, which may be caused by communication delay between the MFP 10 and the time information providing server.

Further, the MFP 10 sets the time running in the MFP 10 to the time indicated in the time information with halved duration of the round-trip communication measured in S320a being added. Therefore, the time of the MFP 10 can be set by adjusting and utilizing the duration of the round-trip communication having been measured, and the time running in the MFP 10 can be more accurately updated compared to a case in which the time indicated in the time information is used to set the time without adjustment.

The MFP 10 according to the above embodiment transmits ping commands preliminarily to the time servers 50, 60, 70 (S210) and to the time information providing server (S310) prior to transmission of the primary data (S220) and prior to the request command (S320) so that network-conditioning minimal command data, i.e., the ping command, can be used to obtain replies from the time servers 50, 60, 70 and the time information providing server quickly.

Further, the MFP 10 is configured to activate the time information provider selecting process, the round-trip duration measuring process, and the time information acquiring process periodically at predetermined intervals. Therefore, the processes can be repeatedly activated in order to obtain the time information and duration of the round-trip communication to maintain the time in the MFP 10 accurate.

Although an example of carrying out the invention has been described, those skilled in the art will appreciate that there are numerous variations and permutations of the communication device and the method that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

For example, when the time information acquiring process is configured to be performed after the time information provider selecting process, specifically, immediately after round-trip duration measuring process, the preliminary communication in S310 can be omitted.

What is claimed is:

1. A communication device to communicate with a responsive server via a network, wherein the responsive server is capable of responding to a request for time information issued by the communication device, the communication device comprising:
a preliminary data transmitter configured to transmit preliminary data, to the responsive server, prior to transmitting the request for time information; and
a time information requester configured to transmit the request for the time information to the responsive server and receive the time information which is transmitted from the responsive server in response to the request.

2. The communication device according to claim 1,
wherein the preliminary data to be transmitted to the responsive server is a ping command.

3. The communication device according to claim 1,
wherein the preliminary data transmitter and the time information requester are activated at a predetermined interval.

4. The communication device according to claim 1, further comprising:
a time adjuster configured to adjust the time information received by the time information requester, based on transmission time of the request transmitted from the time information requester and receipt time of the time information received by the time information requester.

5. The communication device according to claim 1,
wherein the communication device is capable of communicating with a plurality of responsive servers,
wherein the communication device further comprises:
a duration measurer that transmits first data to each of the responsive servers to measure and collect duration of round-trip communication between the communication device and each of the responsive servers responding to the first data;
a time information provider selector that compares the collected duration of round-trip communication between the communication device and each of the responsive servers, and selects one of the responsive servers, which recorded shortest duration for the round-trip communication, as the providing server to which the time information requester transmits the request.

6. The communication device according to claim 5,
wherein the preliminary data transmitter further transmits preliminary data to each of the responsive servers, before the duration measurer transmits the first data to each of the responsive servers.

7. A communication device to communicate with a responsive server via a network, wherein the responsive server is capable of responding to data transmitted from the communication device, the communication device; comprising:
a preliminary data transmitter configured to transmit preliminary data to the responsive server, prior to transmitting primary data; and
a duration measurer that transmits the primary data to the responsive server in order to measure and collect duration of round-trip communication between the communication device and the responsive server responding to the primary data.

8. The communication device according to claim 7,
wherein the preliminary data to be transmitted to the responsive server is a ping command.

9. The communication device according to claim 7,
wherein the communication device is capable of communicating with a plurality of responsive servers,
wherein the duration measurer transmits the primary data to each of the responsive servers to measure and collect duration of round-trip communication between the communication device and each of the responsive servers responding to the primary data;
wherein the communication device further comprises:
a selector configured to compare the collected duration of round-trip communication between the communication device and each of the responsive servers and selects one of the responsive servers, which recorded shortest duration for the round-trip communication, as a time information providing server; and
a time information requester configured to transmit a request for time information to the time information providing server and to receive the time information issued and transmitted from the time information providing server in response to the request.

10. The communication device according to claim 9,
wherein the preliminary data transmitter and the duration measurer are activated at a predetermined interval.

11. A computer usable medium to store computer readable instructions to manipulate a communication device to communicate with a responsive server via a network, wherein the responsive server is capable of responding to a request for time information issued by the communication device, the instructions manipulating the communication device to:
transmit preliminary data to the responsive server, prior to transmitting the request for time information;
transmit the request for the time information to the responsive server; and
receive the time information which is transmitted from the responsive server in response to the request.

12. A computer readable medium to store computer readable instructions to manipulate a communication device to communicate with a responsive server via a network, wherein the responsive server is capable of responding to data transmitted from the communication device, the instructions manipulating the communication device to:
transmit preliminary data to the responsive server, prior to transmitting the primary data;
transmit the primary data to the responsive server; and
transmit the primary data to the responsive server in order to measure and collect duration of round-trip communication between the communication device and the responsive server responding to the primary data.
